(19) United States
(12) Patent Application Publication
(10) Pub. No.: US 2025/0245762 A1
(43) Pub. Date: Jul. 31, 2025

(54) Method and System to Generate Patent Claim Charts

(71) Applicant: Daniel Lin, San Francisco, CA (US)

(72) Inventor: Daniel Lin, San Francisco, CA (US)

(21) Appl. No.: 18/424,829

(22) Filed: Jan. 28, 2024

(51) Int. Cl. G06Q 50/18; G06F 40/40

(52) U.S. Cl. CPC G06Q 50/184; G06F 40/40

(57) ABSTRACT

Methods and systems are described for assisting a user to generate patent claim charts by leveraging the capabilities of large language models (LLMs). Prompts are provided to LLMs at a claim element granularity level to assess possible disclosure of patent claims in prior art and users are able to engage in real-time conversations with the LLMs regarding their analysis to further understand the prior art and refine the analysis.

### BACKGROUND

Searching for and reviewing prior art documents to assess the validity of an issued patent claim or the viability of a proposed patent application claim is a time consuming and labor-intensive process that requires both significant technical and legal expertise. Patent professionals typically utilize available database search tools to search both patent and non-patent literature to identify prior art documents. These search tools assist the patent professional in narrowing down the amount of prior art documents that needs to be reviewed. However, the patent professional is still required to substantially examine a significant number of prior art documents. This involves interpreting, analyzing, and comparing their intricate technical details with those of the patent claim, as well as the patent itself. Given their nature, these prior art documents are frequently dense, challenging to understand, and may employ diverse terminology to express similar technical concepts. Additionally, the necessity to meticulously map each element of a patent claim to suggestions or teachings in prior art documents when determining whether a patent claim is anticipated or obvious intensifies the complexity.

Accordingly, patent professionals must often invest considerable time in analyzing a prior art document, only to ultimately determine that it is not suitable or relevant as prior art for the patent claim. Moreover, the involvement of various types of patent professionals is typically necessary at different stages of these assessments. For instance, patent search firms, equipped with broad technical knowledge and lower costs, may carry out preliminary searches to pinpoint pertinent prior art. Subsequently, patent attorneys, requiring a deeper evaluation of the identified prior art in relation to the patent claim, may develop claim charts to assess the strength of such identified prior art. In doing so, they may also collaborate with specialized technical experts that assist both in further detailed searching and in formulating robust technical arguments. As such, these assessments are often costly projects.

Recent developments in artificial intelligence (AI) have led to the availability of sophisticated large language models (LLMs) such as GPT from OpenAI, Claude from Anthropic and Gemini from Google. These LLMs are a substantial advancement in natural language processing, with the capability to comprehend and generate text that closely resembles human communication, alongside the capacity to efficiently process and analyze extensive volumes of text. These capabilities make LLMs particularly suitable for aiding in the assessment of prior art in relation to patent claims. Equipped with a blend of technical knowledge and legal insight as a result of their training sets, LLMs can navigate and interpret complex patent documents, minimizing human error. They are especially adept at discerning conceptual linkages and contextual connections between diverse technical documents.

### SUMMARY

Methods and systems are disclosed herein for efficiently navigating a patent professional through repeatable business processes or workflows for generating claim charts by leveraging the capabilities of LLMs. By providing a web application that can assist patent professionals in consistently generating multiple claims charts in parallel for selected prior art, the techniques discussed herein focus patent professionals on reviewing selected prior art that is more likely to invalidate a patent claim and significantly reduce their time spent reviewing the prior art documents that may not yield a significant outcome. The techniques herein also provide patent professionals the ability to efficiently identify possible combinations of prior art for obviousness assessments that they may not otherwise have discerned.

One method that generates a claim chart for a patent claim against a prior art document can be performed, in one embodiment, by a web application that provides a service platform as further detailed herein. The method first divides the patent claim into a plurality of claim elements. For each claim element, the method generates a prompt for an LLM to assess whether the claim element is disclosed by the prior art document. To provide proper context for the LLM, the service platform includes the prior art document, the patent claim, and the claim element in the prompt. After transmitting each of the prompts to the LLM and obtaining an initial analysis for each claim element back in response, the service platform presents a claim chart to the user that maps each of the claim elements in the claim to the corresponding initial analysis provided by the LLM.

While the claim chart and the initial analyses therein may be reasonably precise depending on the capabilities of the LLM used, the patent professional may desire to further interrogate the analysis or better understand the prior art document or related technology, for example, prior to devoting significant time to read the prior art document. As such, for each initial analysis presented in the claim chart, the method provides a chat interface to enable the patent professional to engage in a real-time conversation with the LLM, wherein the LLM is instructed to respond to (i) the user's feedback regarding the prior art document or the initial analysis, and (ii) provide an updated analysis of the claim element as a result of the real-time conversation. If the updated analysis is satisfactory, the method provides the patent professional an option to replace the initial analysis with the updated analysis in the claim chart.

Embodiments may further enable the patent professional to assess possible combinations of prior art for obviousness assessments, by identifying to the service platform a second prior art document to analyze with respect to one of the claim elements. The method then generates a prompt for the LLM to assess whether there is a motivation to combine the second prior art document with the first prior art document to render the claim element obvious, wherein, again to provide the LLM context, the prompt includes the prior art document, the second prior art document and the claim element. Upon receiving a motivation to combine analysis from the LLM after transmitting the prompt to the LLM, the method provides the patent professional an option to add the motivation to combine analysis to the claim chart. An embodiment of this method may further provide a chat interface to enable the patent professional to engage in a real-time conversation with the LLM, wherein the LLM is instructed to respond to (i) the patent professional's feedback regarding the motivation to combine analysis, and (ii) provide an updated motivation to combine analysis of the claim element as a result of the real-time conversation.

Additional techniques also enable patent professionals to quickly identify possible combinations of prior art that may have potential for obviousness analysis. In accordance with teachings herein, patent professionals can generate multiple claim charts in parallel for a number of different prior art documents and by using a rating of the strength of the claim element analyses provided by the LLMs, embodiments of the service platform are able to assess whether the rating of an initial analysis of a claim element for a prior art document is weaker than the rating of an initial analysis of the claim element for another analyzed prior art document and present an option to request that the LLM evaluate a motivation to combine the prior art document with the other prior art document if the initial analysis for the prior art document is weaker than the initial analysis for the other prior art document. If the motivation to combine analysis provided by the LLM is satisfactory, service platform can provide the user an option to add a motivation to combine analysis to the claim chart.

### BRIEF DESCRIPTION OF THE DRAWINGS

FIG. 1 depicts a system architecture of a service platform for generating claim charts in accordance with an embodiment of the invention.

FIG. 2 depicts a component architecture of the service platform in accordance with an embodiment of the invention.

FIG. 3A depicts a flow chart for generating a claim chart using the service platform in accordance with one embodiment of the invention.

FIG. 3B depicts a flow chart for adding a motivation to combine analysis to the claim chart in accordance with an embodiment of the invention.

FIGS. 4A-4M depict various user interfaces of the service platform in accordance with an embodiment of the invention.

### DETAILED DESCRIPTION

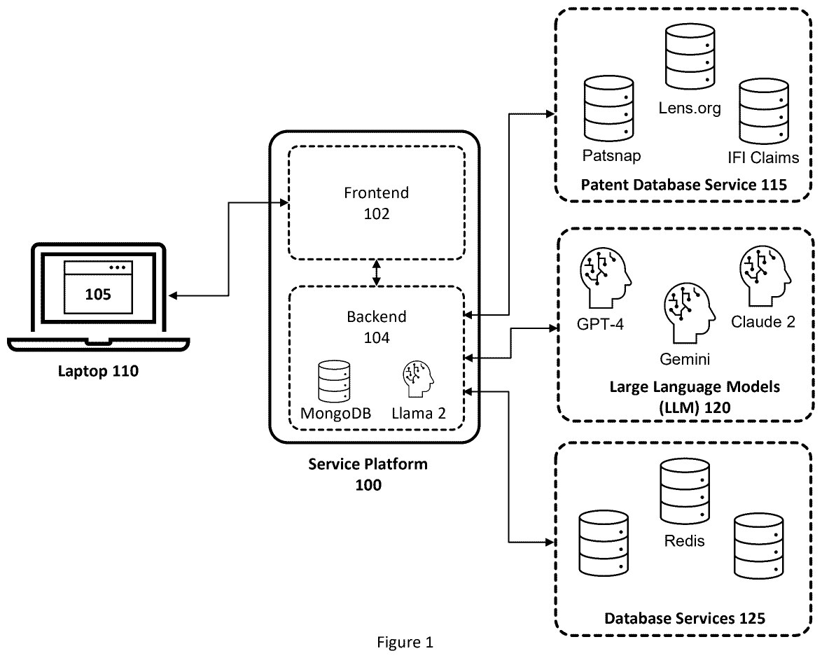

FIG. 1 depicts a system architecture of a service platform for generating claim charts in accordance with one embodiment of the invention. Service platform 100 serves a web application to a user's endpoint device, such as a web browser 105 running on a laptop 110. As depicted, service platform 100 includes a client-side frontend component 102 that provides the user interfaces that the user interacts with through web browser 105. Frontend 102 may be developed using well known frontend frameworks such as Angular, React and the like. Service platform 100 also includes a server-side backend 104 that receives user interactions through frontend 102 and performs required operations (e.g., requesting, processing, managing and storing data) to respond to those user interactions. Backend 104 may be developed using well-known technologies and platforms such as Node.JS, Python, Java or Ruby. Service platform 100 may be instantiated on an infrastructure cloud platform, such as Amazon AWS, Google Cloud or Microsoft Azure, and may leverage and include such infrastructure cloud platforms' various orchestration, deployment, database, load balancing and scaling tools and services. To obtain patent data, such as patent claims, specifications and other meta-data (e.g., title, dates, inventors, owner, etc.) as further described below, backend 104 may interact with one or more third party patent database platforms, collectively referred to as patent database service 115. For example, backend 104 may utilize application programming interfaces (APIs) made available by Lens.org, Patsnap, IFI CLAIMS Patent Services or any other known patent database platforms or services. Similarly, to generate various analyses for the claim charts, service platform may interact with one or more large language models (LLMs), collectively referred to as LLM 120. LLM 120 may include, for example, OpenAI's GPT-4 service, Anthropic's Claude 2 service, Google's Gemini service and/or other similar third party LLM platforms. In certain embodiments, LLM 120 may further include open source LLMs, such as Meta's Llama 2, which service platform 100 may stand up as part of its own infrastructure (e.g., depicted inside backend 104 in FIG. 1). Similarly, certain embodiments of service platform 100 may leverage third party database services 125, such as Redis Enterprise and other similar third party database services, to store or cache generated claim charts, workspaces, LLM conversations, and other persistent data as further described herein. Additionally or alternatively, as depicted inside backend 104 in FIG. 1, service platform 100 may utilize standard database such as MySQL, PostgresSQL, MongoDB and the like as part of its own infrastructure as its database services 125.

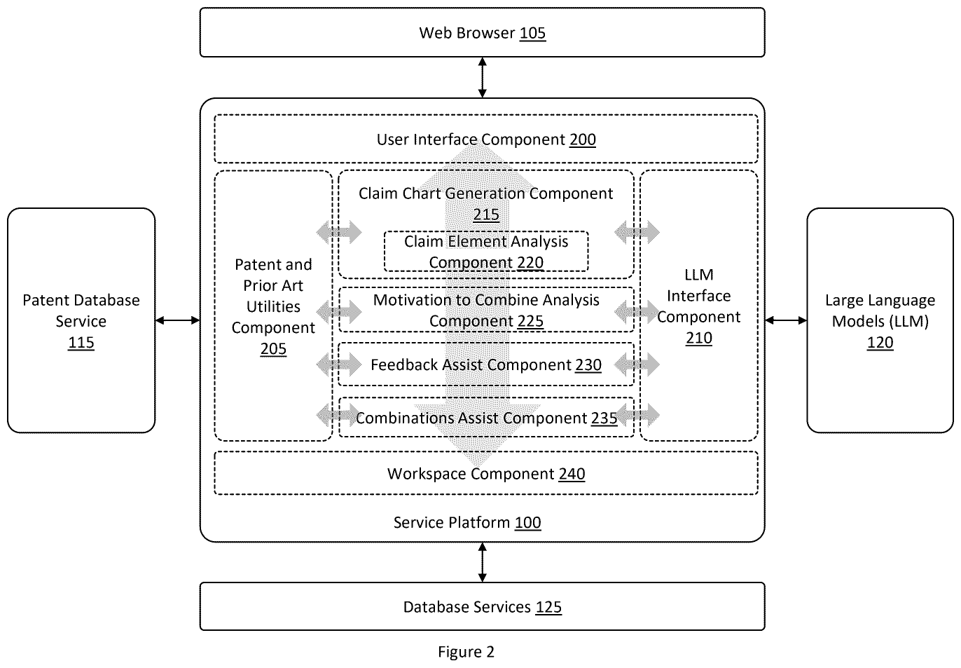

FIG. 2 depicts a high-level component architecture for a service platform in accordance with an embodiment of this invention. Frontend 102 and backend 104 of service platform 100 may work together to provide the functionality in these logical components. It should further be recognized that, depending on the programming languages and platforms used to program an embodiment of service platform 100, the components of FIG. 2 may be implemented using a multitude of programming techniques and constructs, such as objects, classes, interfaces, methods, services, and the like.

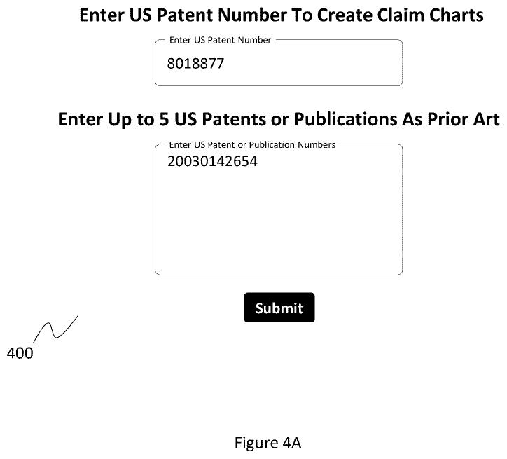

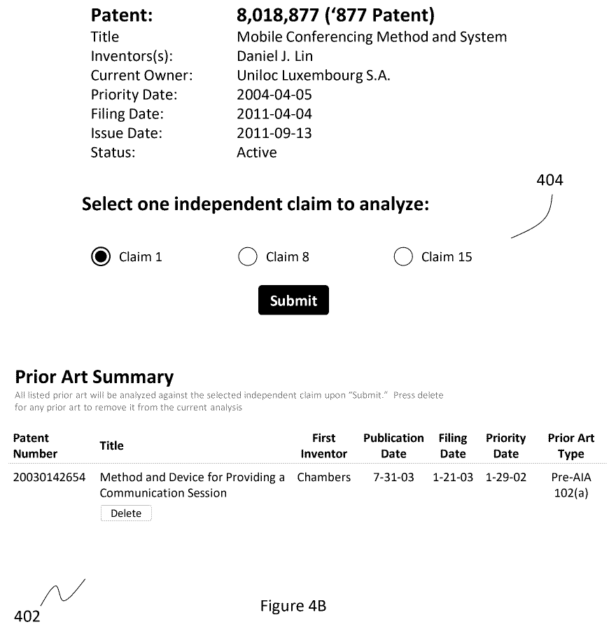

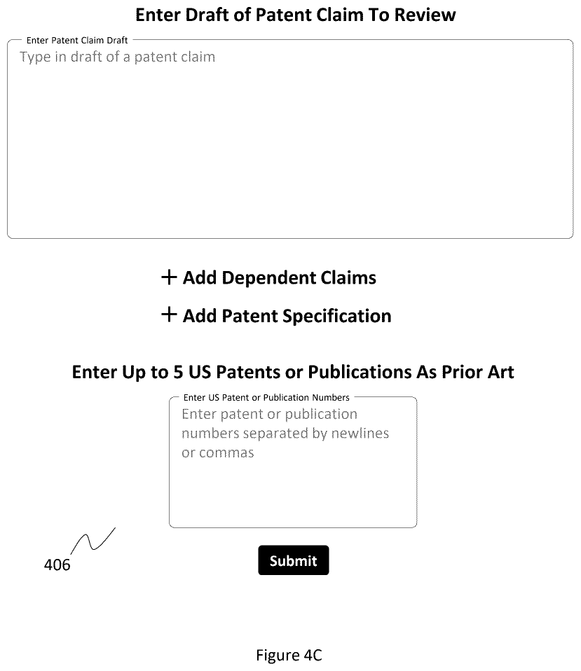

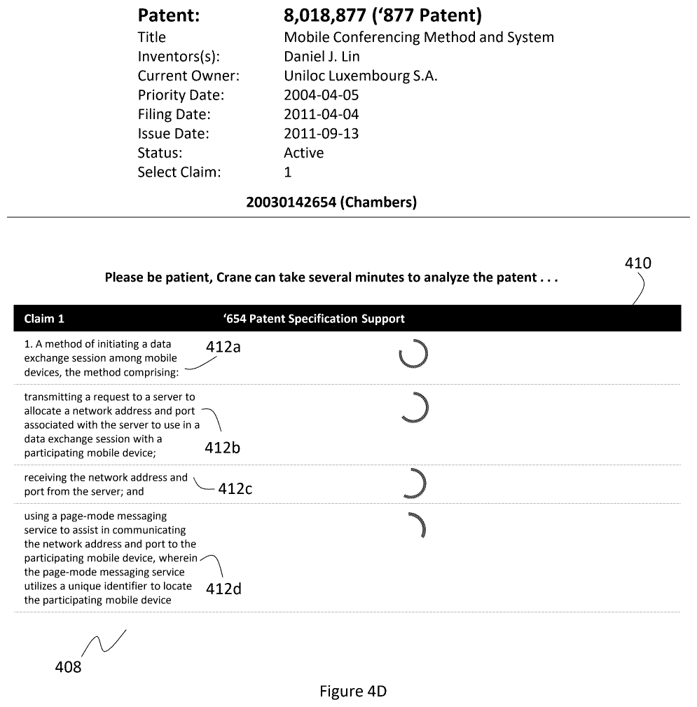

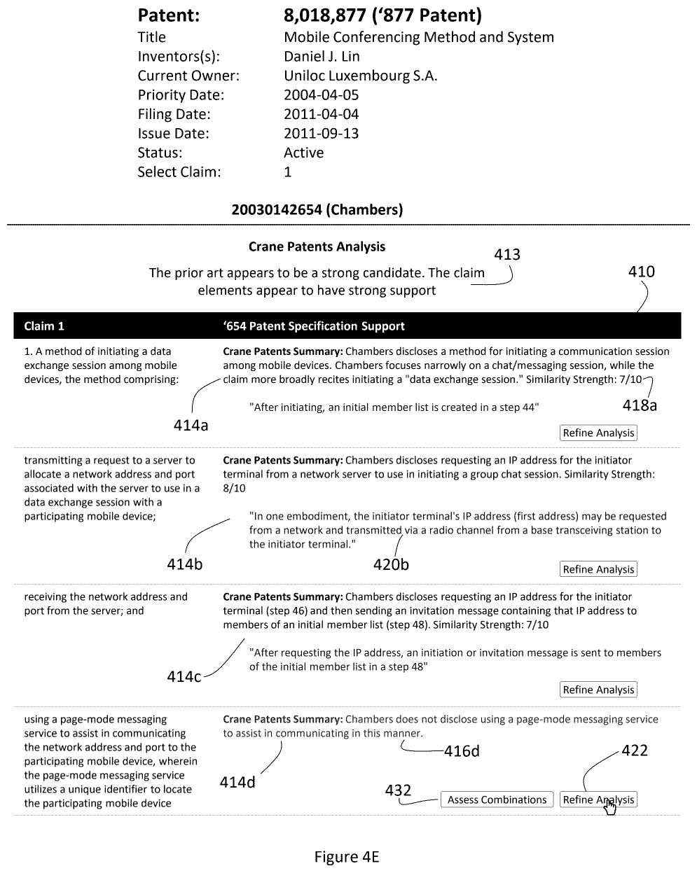

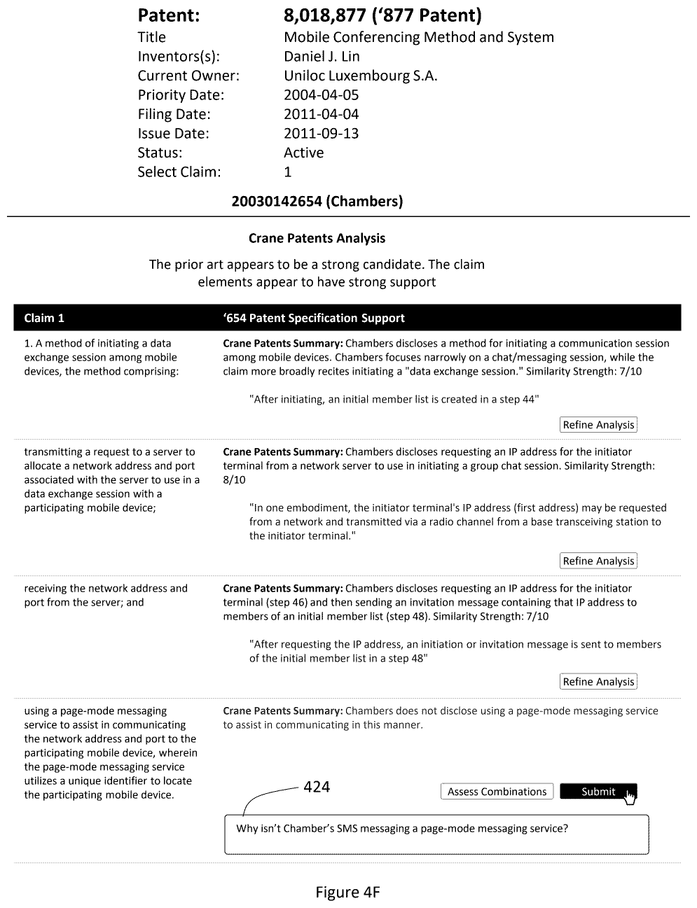

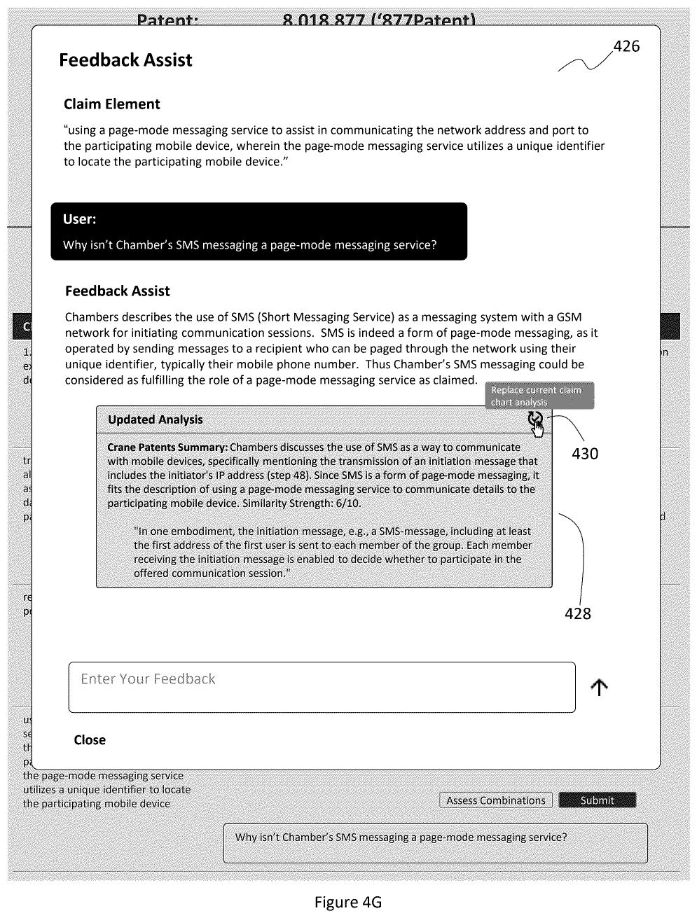

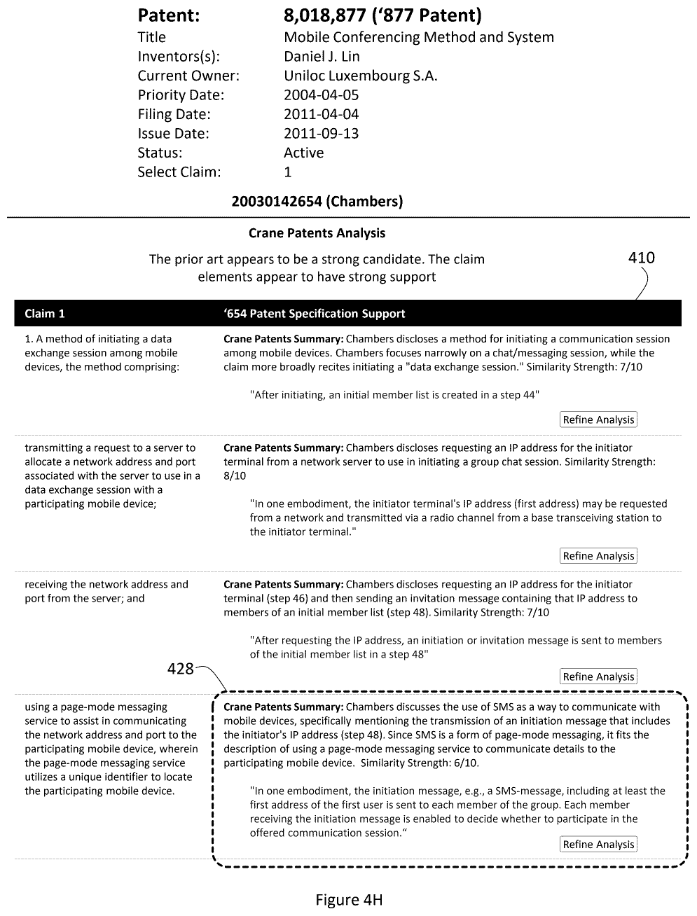

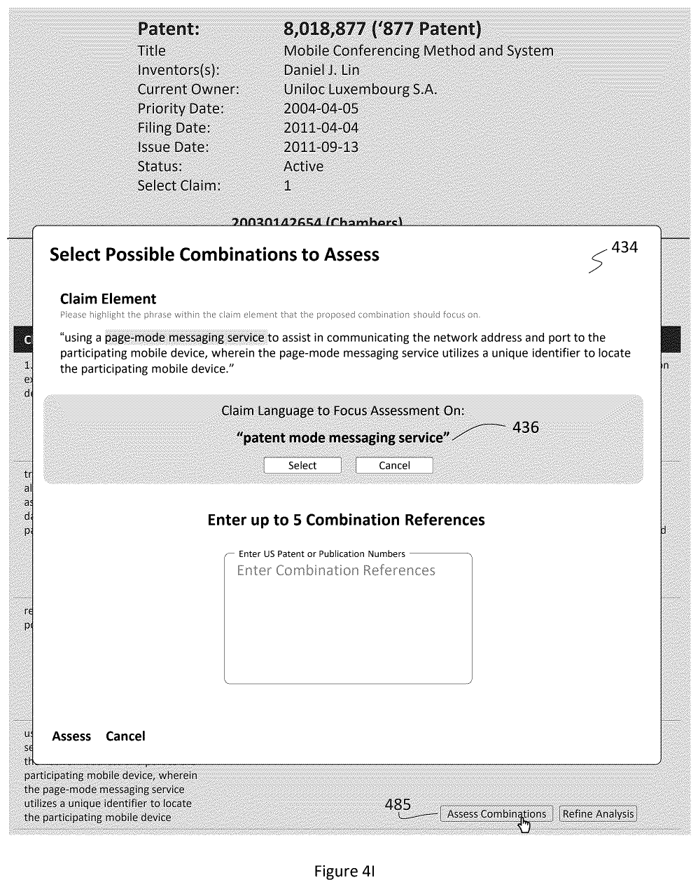

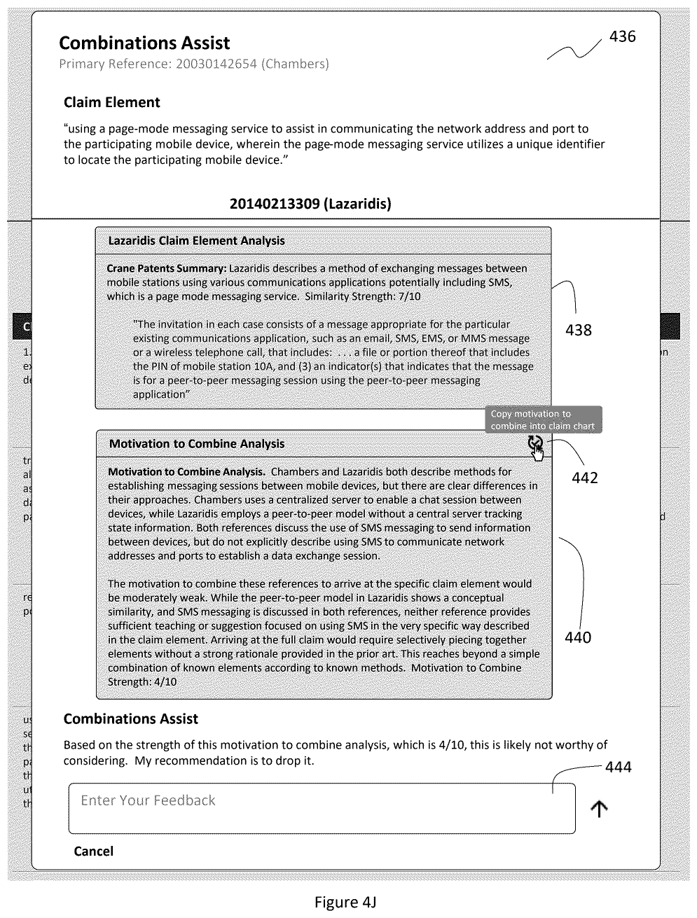

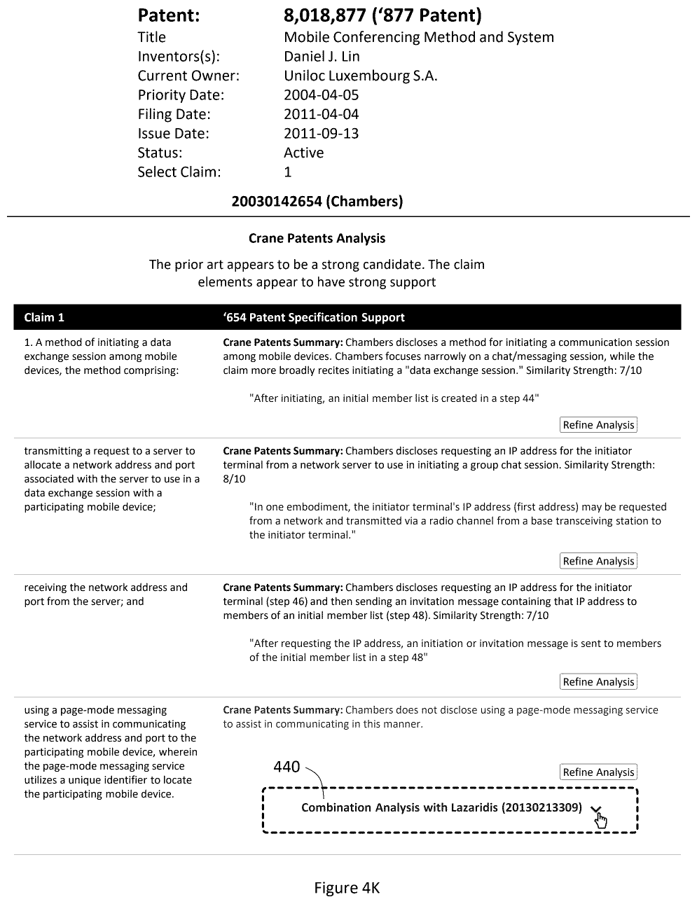

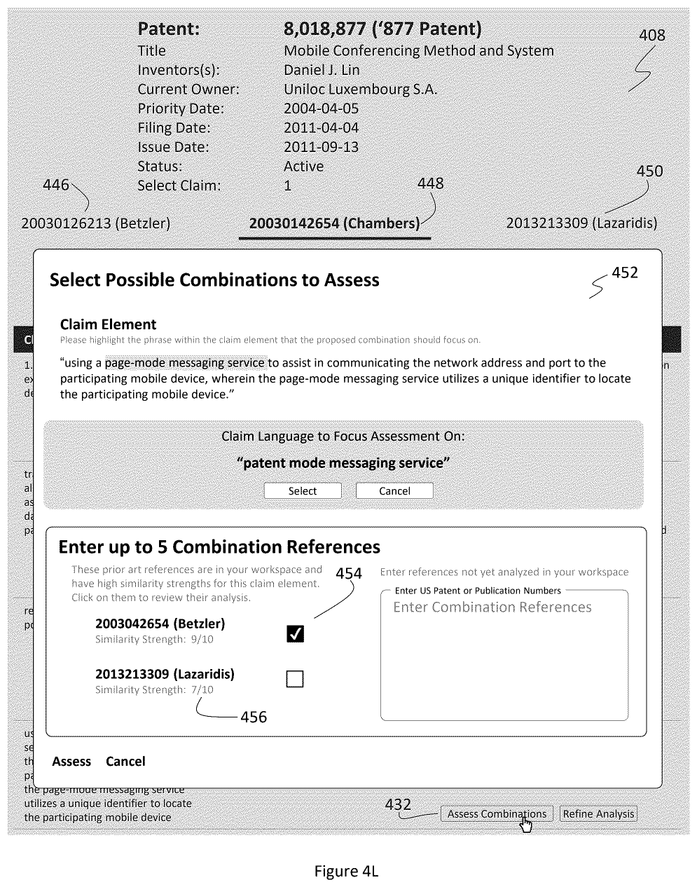

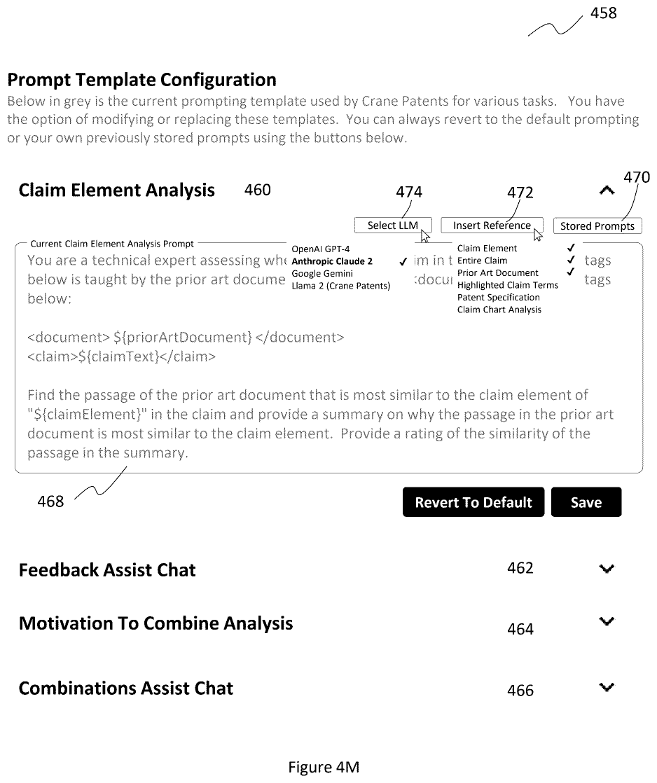

As depicted in FIG. 2, service platform 100 comprises a user interface component 100 that interacts with the user's web browser 105 and assists in rendering graphical user interfaces, such as FIGS. 4A-4M as further described below. Each of the other substantive components of service platform 100 may need to interface with user interface component 200 in order to obtain responses for the user or convey results to the user. Similarly, service platform 100 comprises a patent and prior art utilities component 205 that serves as an interface to patent database service 115. When the other components need to access patent or prior art data, such as patent specifications, claims, titles, inventor names, filing and priority dates, issue dates, drawing, figures, and the like, or need to process such data in some manner, they may request the data or the processing of such data from patent and prior art utilities component 205. Service platform 100 includes a similar LLM interface component 210 that services as an interface to LLM 120. When the other components need access to LLM 120, for example, to analyze prior art documents against patent claims or to engage in real-time conversations as further discussed below, they may request such access through LLM interface component 210. Embodiments of LLM interface component 210, for example, are able to interface with the various different LLMs in LLM 120 (e.g., Claude 2, GPT-4, Gemini, etc.) through each of their different APIs.

In the embodiment of FIG. 2, service platform 100 includes a claim generation component 215 that interfaces with user interface component 200, patent and prior art utilities component 205 and LLM interface component 210 to generate and manage claim chart creation in accordance with the teachings herein. For example, in one embodiment, claim chart generation component 215 may create a claim chart object for each patent number, patent claim set (e.g., independent claim and claims dependent thereupon) and prior art document combination submitted by users. Claim chart generation component 215 may include a claim element analysis sub-component 220 that generates and maintains a claim element analysis object for each claim element in the patent claim set.

Service platform 100 may further include a feedback assist component 230 to assist a user in further refining the claim chart analyses provided by LLM 120 by providing real-time conversation capabilities with LLM 120. For example, feedback assist component 230 may interface with user interface component 200, patent and prior art utilities component 205, LLM interface component 210 and claim chart generation component 215 to display a chat interface to the user on web browser 105, generate prompts that include relevant patent data as context for LLM 120, broker a conversation between the user and LLM 120 to refine the claim element analyses provided by LLM 120 and update claim charts as desired.

Embodiments of the invention may also comprise a motivation to combine analysis component 225, which interfaces with user interface component 200, patent and prior art utilities component 205, LLM interface component 210 as well as claim chart generation component 215 to assist with exploring the possibility of combining additional prior art with the primary prior art of a claim chart to assess obviousness. Motivation to combine analysis component 225 may be further supplemented with a combinations assist component 235 that brokers a real-time conversation between LLM 120 and the user on web browser 105 to further analyze and refine motivation to combine analysis provided by LLM 120 (in a similar manner as feedback assist component 230).

Finally, embodiments may include a workspace component 240 as depicted in FIG. 2, which persists user “workspaces” to persistent storage using database services 125. For example, a user workspace may comprise a number of related claim charts for a number of patent claims and prior art documents that may be related in some manner (e.g., related to a particular litigation or licensing negotiation project, etc.). The other components of service platform 100 may request that workspace component store various claim chart and claim element analysis objects, motivation to combine analysis or real-time conversations related there, such that they can be retrieved, reviewed and refined in the future.

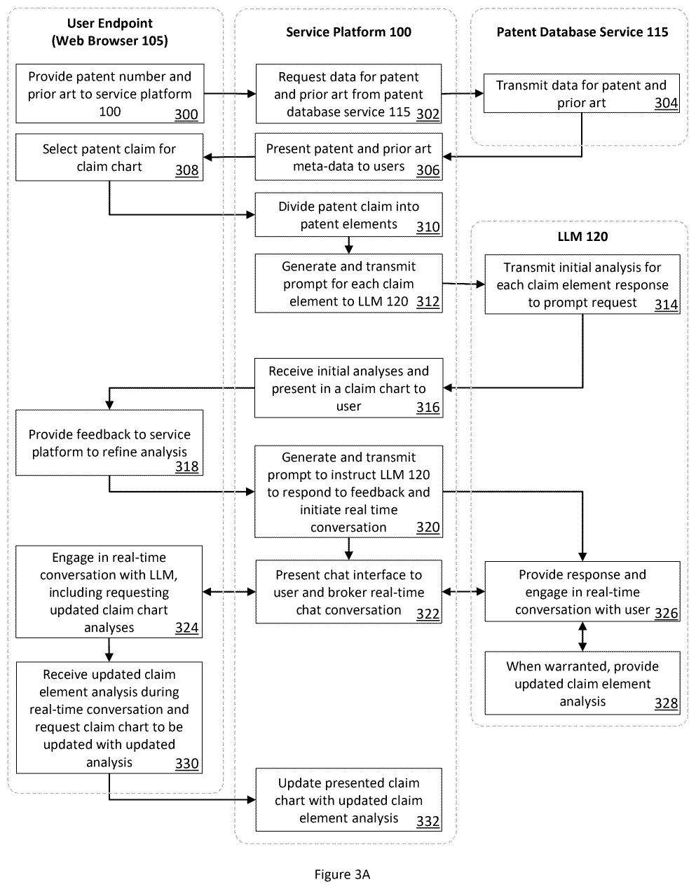

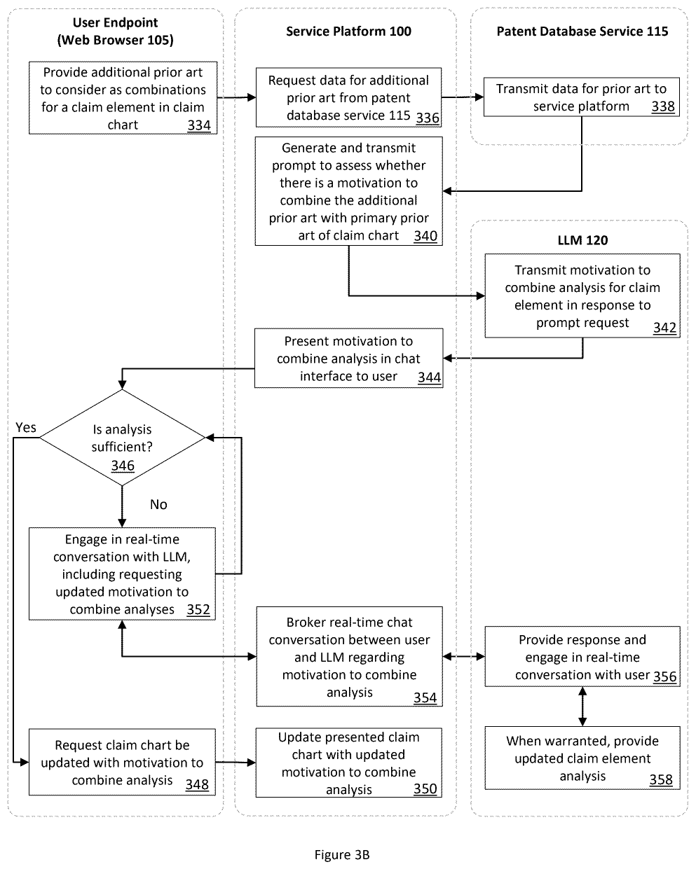

FIGS. 3A and 3B depict generating a claim chart using service platform 100 in accordance with embodiments of the invention. In step 300, a user enters a patent number and at least one prior art document number, such as a patent or publication number. FIG. 4A depicts an embodiment of user interface corresponding to step 300. As depicted, user interface 400 is presented on a web browser and enables the user to enter a US patent number and up to 5 US patent numbers or US patent publication numbers as prior art documents. It should be recognized that alternative embodiments could enable the user to enter more and different identification numbers, including non-US patents and publications as well as citations for non-patent literature.

In step 302, service platform 100 receives the patent number and prior art selections from the user and requests data for them from patent database service 115 (e.g., via APIs). For example, such data would include the title, inventor, various dates, owner, text of the specification, text and organization of the claims and other meta-data made available by patent database service 115. Patent database services provides the requested data in step 304 and service platform 100 presents at least a portion of that data to the user in step 306 so that the user may select one of the independent claim numbers of the entered patent to evaluate against the submitted prior art in step 308. FIG. 4B depicts an embodiment of a user interface for step 306. As depicted, user interface 402 enables the user to select one of the independent claims (as well as remove any submitted prior art document that the user may wish to remove from the evaluation). In the embodiment of FIG. 4B, service platform 100 has processed the received patent data from step 304 to identify and display the independent claims 404 (and other displayed meta-data of the identified patent and prior art document, such as title, inventor names, owner, dates, status, etc.) as depicted.

In alternative embodiments, FIGS. 4A and 4B (and steps 300-308) may be replaced with steps where the user submits a draft of a claim rather than a patent number. FIG. 4C depicts a user interface for such an embodiment. As depicted, in the embodiment of FIG. 4C, the user can submit draft claims, as well as a draft specification, in addition to entering a number of prior art document numbers (or other identifiers) through user interface 406.

Upon receipt of a patent claim and prior art document numbers, in step 310, service platform 100 divides the patent claim into a plurality of default claim elements or phrases. For example, it is common practice to break up a patent claim into claim elements that are separated by semi-colons used by the claim drafter to separate limitations that make up the claimed invention. Alternative embodiments may provide options to a user (e.g., through user interface interactions) to divide the patent claim into custom claim elements or further refine the default claim elements, for example, breaking them up into further claim elements or further enabling the user to highlight or identify more specific language in the claim element that is of particular importance.

In step 312, for each claim element, service platform 100 generates a prompt to LLM 120 to assess whether the claim element is disclosed by the prior art document. For example, in one embodiment, service platform 100 includes the prior art document(s) from patent database service 115 (e.g., as part of step 304) and combines it with the text of the patent claim, including the specific claim element, to generate a prompt using a template such as the one below:
You are a technical expert assessing whether the patent claim in the <claim></claim> tags below is taught by the prior art document, provided in the <document></document> tags below:
<document> ${priorArtDocument} </document>
<claim>${claimText}</claim>
Find the passage of the prior art document that is most similar to the claim element of “${claimElement}” in the claim and provide a summary on why the passage in the prior art document is most similar to the claim element. Provide a rating of the similarity of the passage in the summary.

Alternative embodiments may use only portions of the prior art document (e.g., only the “Detailed Description” of a prior art document, etc.) in the prompt or may break down the requested assessment into a series of more targeted prompts to solicit the ultimate desired response from LLM 120. For example, embodiments may utilize multiple prompts to first engage LLM 120 to ascertain whether a passage with strong enough similarity exists in the prior art document before requesting LLM 120 to summarize the similarity of such a passage in subsequent prompts.

Service platform 100 transmits each of these prompts to LLM 120 to obtain an initial analysis for each claim element. For example, in one embodiment, service platform 100 may transmit the prompts to LLM 120, which includes Anthropic's Claude LLM, through the Claude API. Once LLM 120 transmits the initial analyses for each claim element back to service platform 100 in step 314, service platform 100 then presents the results in a claim chart to the user in step 316. FIG. 4D depicts a user interface for steps 310-316 in accordance with an embodiment of the invention. In user interface 408, service platform 100 displays a template claim chart 410 while awaiting results from LLM 120. As depicted, the patent claim has been divided into claim elements 412-412d (also each generally referred to, as 412x) in claim chart 410 and prompts for each claim element 412x have been transmitted to LLM 120. In claim chart 410 as depicted in FIG. 4E, LLM 120 has responded to service platform 100 with an initial analysis 414a-414d (also each generally referred to as 414x) for each claim element and service platform 100 has displayed them in claim chart 410 for each corresponding claim element. For ease of review, service platform 100 has provided an overall high-level summary 413 of the results of the claim chart. Each initial analysis 414x of the claim elements in the embodiment of FIG. 4E has a summary 416x (including a rating 418x) as well as quoted passages 420x from the prior art document (for simplicity, only 416d, 418a and 420b have been expressly labeled in FIG. 4E as examples).

Once claim chart 410 has been populated with an initial analysis 414x for each claim element, embodiments of the invention may further provide an ability for the user to refine the initial analysis through additional engagement with LLM 120. As depicted in FIG. 4E, a “Refine Analysis” button 422 is presented for each claim element 412x in claim chart 410. As depicted in the embodiment of FIG. 4F, upon a user's selection of button 422, a text area 424 is presented for the user to input feedback in step 318.

Returning to FIG. 3A, upon receiving the user's feedback in text area 424 in step 318, service platform 100, in step 320, generates a prompt to instruct LLM 120 to respond to the user's feedback regarding the prior art document or the initial analysis. For example, in one embodiment, a template for prompt generation by service platform 100 may be similar to the below:
You are a technical expert analyzing a patent claim, in <claim></claim> tags below, against a prior art document provided in the <document></document> tags below. A preliminary analysis is provided in the <analysis></analysis> tags below.
<claim>${claimText}</claim>
<document>${priorArtDocument}</document>
<analysis>${claimChartInitialAnalysis}</analysis>
The user requires assistance to assess the part of the preliminary analysis that addresses the claim element in the <element></element> tags below.
<element>${claimElement}</element>
You may respond to the user's general questions about the prior art document, the related technology or the preliminary analysis with respect to the claim element. If appropriate, you can respond by providing an updated analysis for the claim element in the preliminary analysis.

In such an embodiment, LLM 120 may include OpenAI's GPT LLM and service platform 100 may utilize OpenAI's “chat completion” API to enable the user to engage in a real-time conversation with LLM 120 to refine the initial analysis for the claim elements. Service platform 100 transmits the generated prompt and the user's initial feedback (e.g., from text area 424) to LLM 120 and, in step 322, presents a chat interface to the user to manage and broker a real-time conversation with LLM 120, as depicted additionally in steps 324 for the user and 326 for LLM 120. In certain embodiments, as a result of the prompting instructions to LLM 120 generated by service platform 100, the user is able to ask general questions about the prior art or the related technology in addition to specific questions about the claim element analysis. This enables the user to reduce significant time spent directly reviewing the prior art and applying it to the claim element, for example. FIG. 4G depicts an embodiment of a chat interface 426 presented by service platform 100 in step 322. As a result of the conversation between the user and LLM 120 through chat interface 426, in step 328, LLM 120 may provide an updated analysis 428 for the claim element in step 324. Updated analysis 428, as depicted in FIG. 4G and step 330 of FIG. 3A, may include an option, such as button 430, for the user to replace the initial analysis 414d with the updated analysis 428 in claim chart 410 as depicted in the updated analysis 428 as copied into claim chart 410 in FIG. 4H and step 332 of FIG. 3A.

As depicted in FIG. 4E through an “Assess Combinations” button 432, in certain embodiments, the user may also explore combining the prior art document corresponding to claim chart 410 with additional prior art documents to assess whether a claim element 414x may be rendered obvious by a combination of such prior art. In step 334 of FIG. 3B, the user provides the identification of one or more other prior art documents, for example, through the user interface 434 as depicted in the embodiment of FIG. 4I. As shown in FIG. 4I, the user may have an additional option 436 to highlight specific language in the claim element to focus a motivation to combine analysis upon. And as previously discussed, such an option to identify specific language in claim elements for additional focus may also be provided by user interfaces (e.g., such as user interface 426) when a user engages in a real-time conversation to further refine the initial analyses 414x, as depicted in FIG. 4G and described earlier.

In steps 336 and 338, service platform 100 requests data for the prior art from patent database service 115 and patent database service 115 provides such data in response. In step 340, service platform 100 generates a prompt for LLM 120 to assess whether there is a motivation to combine the prior art documents (each, a “secondary prior art document”) entered in step 334 (e.g., through user interface 434) with the claim chart's prior art document (sometimes referred to as the “primary prior art document”) to render the claim element obvious. For example, in one embodiment, a template for prompt generation by service platform 100 for such a motivation to combine analysis may include portions of the primary prior art document, portions of the secondary prior art documents and the claim element, similar to the below:
You are a technical expert analyzing the strength of the motivation to combine a primary prior art document, in <primary-document></primary-document> tags below, with a secondary prior art document, in <secondary-document></secondary-document> tags below, to arrive at a claim element in a patent claim.
The patent claim is provided in <claim></claim> tags below and you will focus on the specific claim element, “${claimElementText},” in the claim, with a particular emphasis on the phrase “${elementFocusText}” in the claim element.
You will specifically assess whether you would have been motivated to combine the primary prior art document with secondary prior art document to arrive at the claim element.
<primary-document>${primaryReference}</primary-document>
<secondary-document>${secondaryReference}</secondary-document>
<claim>${claimText}</claim>
Provide a summary on the strength of the motivation to combine the primary prior art document with the secondary prior art document to arrive at the claim element in the patent claim, including a rating of the strength of the motivation to combine.

Service platform 100 transmits the generated prompt to LLM 120 and, in step 342, LLM 120 transmits a motivation to combine analysis to service platform 100 and, in step 344, service platform 100 receives and presents the analysis in a chat interface to enable the user to engage in a real-time conversation with LLM 120 regarding it. FIG. 4J depicts an embodiment of a chat interface 436 presented by service platform 100 in step 344. As depicted in the embodiment of FIG. 4J, service platform 100 first prompts LLM 120 to provide a claim element analysis 438 of the claim element against the secondary prior art document (similar to step 312 in FIG. 3A) in addition to prompting LLM 120 for motivation to combine analysis 440 in step 340. In the embodiment of FIG. 4J, claim element analysis 438 may be included in the motivation to combine prompt generated in step 340 by service platform for additional context. If the user decides that motivation to combine analysis 440 is sufficient in step 346, as depicted in FIG. 4J, the user may utilize button 442 to request, in step 348, that service platform 100 add it into claim chart 410, as shown in FIG. 4K (depicted as an expandable panel) and described in step 350 of FIG. 3B.

If the user requires further refinement of motivation to combine analysis 440, similar to chat interface 426 of FIG. 4G, the user is also able to engage in a real-time conversation with LLM 120 (e.g., through text area 444 of FIG. 4J) to refine motivation to combine analysis 440, as set forth in steps 352-356. Upon receiving feedback from the user in text area 444, in step 354, service platform 100, for example, may transmit a prompt for LLM 120, instructing it to respond (e.g., including as a real-time conversation through multiple prompts) to the user's feedback regarding motivation to combine analysis 440 and, if warranted, provide an updated motivation to combine analysis as a result of the real-time conversation in step 358. One example embodiment of a template for such a prompt is below:
You are a technical expert analyzing the strength of the motivation to combine a primary prior art document, in <primary-document></primary-document> tags below, with a secondary prior art document, in <secondary-document></secondary-document> tags below, to arrive at a claim element in a patent claim.
The patent claim is provided in <claim></claim> tags below and you will focus on the specific claim element, “${claimElementText},” in the claim, with a particular emphasis on the phrase “${elementFocusText}” in the claim element.
A preliminary analysis of the motivation to combine has already been performed and is provided in the <analysis></analysis> tags below.
<primary-document>${primaryReference}</primary-document>
<secondary-document>${secondaryReference}</secondary-document>
<claim>${claimText}</claim>\n
<analysis>${motivationAnalysis}</analysis>
The user will provide feedback regarding the motivation to combine analysis provided in the <analysis></analysis> tags. You will respond with to the feedback and if warranted provide an updated motivation to combine analysis based on the conversation.

Returning to step 346 in FIG. 3B, if the updated motivation to combine analysis is sufficient for the user, then the user may request that the updated analysis be copied into the claim chart (i.e., steps 348 and 350). In certain embodiments, when a user has submitted multiple prior art documents to simultaneously assess against a patent claim (e.g., by adding 2 or more prior art documents in FIG. 4A), service platform 100 automatically ascertains the differences in the ratings of the various claim element analyses presented in the respective claim charts for each of the prior art documents and provides suggestions for possible combinations based on those ratings. FIG. 4L depicts an embodiment of user interface 408 with three generated claim charts that have been generated in parallel and are navigable through three tabs, 446, 448 and 450 (with tab 448's claim chart currently selected and displayed). Upon the user's selection of “Assess Combinations” button 432 for the last claim element in the current selected claim chart (i.e., tab 448), service platform 100 presents user interface 452 in order to identify secondary prior art to combine with the primary prior art corresponding to the claim chart at issue. User interface 452 includes a selection panel 454 that lists the other prior art in the user's “workspace” for which claim charts for the patent claim have been generated and are accessible through user interface 408 (e.g., tabs 446 and 450). Selection panel 454 displays ratings 456 of the analysis of the claim element for the other prior art (as made in their respective claim charts) in order to assess whether a motivation to combine analysis may be worthwhile. In certain embodiments, service platform 100 also filters the other prior art, assessing whether the rating of the claim element analysis for the current prior art is weaker than the rating of the claim element analysis of the other prior art and only displaying in selection panel 454 those prior art documents that have a higher rating in their claim element. Such embodiments significantly increase the ability of a user to find possible viable combinations without directly reviewing all the prior art at the claim element level. For example, if the overall summary of a claim chart 410 (e.g., see summary 413 in FIG. 4E) is strong, but it is missing a strong rating or mapping for a particular claim element (e.g., see summary 414d in FIG. 4E), service platform 100 can quickly identify possible combinations with other prior art that have in stronger ratings their claim charts for the claim element. Selection panel 454 provides an option (e.g., checkboxes) for the user to select particular prior art documents to initiate a motivation to combine analysis using LLM 120 as previously discussed (e.g., FIGS. 41 and 4J and accompanying steps in FIG. 3B).

FIG. 4M depicts a user interface for an embodiment of system platform 100 that provides the user an option to modify the default prompt templates used by system platform 100 to interact with LLM 120. As depicted, user interface 458 provides options in expandable panels for a user to revise the prompt templates discussed herein with respect to the claim element analysis 460, the real-time chat to refine the claim element analysis (e.g., “Feedback Assist Chat”) 462, the motivation to combine analysis 464 and the real-time to chat to refine the motivation to combine analysis (“Combinations Assist Chat”) 466. Text area 468 currently displays the default prompt used by service platform 100 to interact with LLM to obtain the initial analyses for each claim element (e.g., see 414x in FIG. 4E and step 312 of FIG. 3). The user can edit the prompting template in text area 468 or can bring up a stored prompt to work with by pressing stored prompts button 470. Using “Insert Reference” button 472, the user can add particular references to the prompting template such as the claim element at issue, the text of the entire claim, the prior art document text (or portions thereof), the patent specification (or portions thereof), highlights claim element terms to focus on, or the claim chart analysis itself (or portions completed at the time). Similarly, using “Select LLM” button 474, the user can select from a multitude of LLM platforms (e.g., GPT-4, Claude 2, Gemini, Llama 2) that make up LLM 120 in an embodiment to utilize with respect to the particular prompting templates.

Although one or more embodiments of the invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

For example, while embodiments of service platform 100 are described as running on a cloud infrastructure platform, it should be recognized that alternative embodiments may run service platform 100 on-premises, for example, in a company's own data center. Similarly, while embodiments have utilized web browser 105 as the example endpoint for a user, it should be recognized that embodiments can be implemented as a standalone application running on a user's endpoint such as a laptop or mobile device. As should be recognized, server-side or “backend” functionality of service platform 100 may be deployed using a variety of modern approaches, such as microservices and “serverless computing” such as AWS Lambda. And while embodiments herein have depicted claim chart 410 as being rendered in web browser 105, it should be recognized that alternative embodiments may provide options to convert and download such claim charts to Word documents that can be edited locally on a user's endpoint.

Examples herein have focused on patent and patent publications as the main forms of prior art; however, it should be recognized that all forms of prior art, including non-prior art literature, can be included in embodiments. For example, alternative embodiments may provide the capability of uploading non-patent prior art documents (e.g., PDFs) or providing links, to the extent that patent database service 115 does not have them. Similarly, while certain examples herein have depicted prompts for LLM 120 as a single prompt, it should be recognized that multiple prompts as well as various prompting techniques (e.g., “N-shot”, chain-of-thought, etc.) can be leveraged in the prompting discussed herein. For example, rather than generating a prompt from a template as discussed herein, for example, in the context of step 312 in FIG. 3, certain embodiments may use the “chat completion” or “conversation” API capabilities of certain LLM platforms such that each prompt for each claim element is an instruction that is appended to the end of a chat or conversation that steps through the claim elements in the order the appear in the claim. Furthermore, embodiments may engage in further fine tuning of LLM 120, for example, providing more relevant documents to train the base models of LLM 120 to provide more accurate responses, such as PTAB inter-partes review briefs and decisions, as well as USPTO re-exam request and office actions, or providing more examples of the preferred articulations for initial analysis 414x, updated analysis 428, motivation to combine analysis 440 and real-time conversations responses with the user.

While embodiments have described a user entering prior art such as in steps 300 and 334 of FIGS. 3A and 3B and corresponding user interfaces such as FIG. 4A, 4I or 4L, alternative embodiments can obtain prior art through other means without user interaction, such as interfacing (e.g., through APIs) with a patent search or patent database service that provides sophisticated patent searching capabilities (e.g., semantic search and other AI techniques, etc.). For example, such services may provide a curated list of prior art upon submission of a patent and/or patent claim to service platform 100, upon which service platform 100 can operate as described herein. Similarly, assessing possible secondary prior art for motivation to combine analysis as discussed herein can be further automated by obtaining such secondary prior art from such patent search services. In certain embodiments, rather than having a user interaction to select possible combinations to explore for a motivation to combine analysis as in FIG. 4L, service platform will automatically conduct motivation to combine analyses by comparing the strength of claim element analysis across generated claim charts. For example, for a primary prior art document having a claim chart that has a strong overall assessment (e.g., see 413 in FIG. 4E) but a weaker individual rating for one or more claim elements (e.g., see 414d in FIG. 4E) when compared to a secondary prior art document's claim chart, service platform 100 would automatically initiate a motivation to combine analysis. In the particular example of FIG. 4L, such an embodiment of service platform 100 would initiate a motivation to combine analysis for both of the prior art documents identified in selection panel 454 since they have stronger analysis for the claim element than the primary prior art document.

Examples herein have also focused on independent claims, but it should be recognized that support for dependent claims can be implemented in embodiments. For example, in certain of such embodiments, service platform 100 may enable a user to add dependent claims to claim chart 410 and request LLM 120 to provide a claim element analysis of the dependent claim (or multiple claim elements in the dependent claim) for incorporation into claim chart 410. In certain embodiments, service platform 100 may incorporate the substantive limitations of a dependent claim into its corresponding independent claim, and utilize the combined claim in its generated prompts for LLM 120.

One or more embodiments of the invention also relate to a system for performing the steps or operations herein. The system may be specially constructed for required purposes, or the system may be one or more general-purpose computers selectively activated or configured by a computer program stored therein. Various general-purpose machines may be used with computer programs written in accordance with the teachings herein, or there may be instances where it is more desirable to construct a more specialized system to perform the required operations.

One or more embodiments of the invention may be implemented as one or more computer programs or as one or more computer program modules embodied in computer readable media. The term computer readable medium refers to any data storage device that can store data that can thereafter be input into a computer system. Computer readable media may be based on any existing or subsequently developed technology that embodies computer programs in a manner that enables a computer to read the programs. Examples of computer readable media are HDDs, SSDs, network-attached storage (NAS) systems, read-only memory (ROM), RAM, compact disks (CDs), digital versatile disks (DVDs), magnetic tapes, and other optical and non-optical data storage devices. A computer readable medium can also be distributed over a network-coupled computer system so that computer-readable code is stored and executed in a distributed fashion.

Further, any logic or component described herein can be implemented and structured in a variety of ways. For example, one or more of the steps in FIG. 3A or 3B or system or architectural components in FIG. 1 or 2 can be implemented as modules or components of a single application or across different applications or infrastructure components. Further, one or more components or functionality described herein can be executed in shared or separate computing devices or a combination thereof. For example, a plurality of the functions described herein can execute in the same computing device, or in multiple computing devices in the same computing environment (e.g., different infrastructure services offered by cloud platforms as discussed herein). Plural instances may be provided for components, operations or structures described herein as a single instance. Finally, boundaries between various components, operations and data stores are only exemplary, and particular operations are illustrated in the context of specific illustrative configurations. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

I claim:

1. A method for generating a claim chart for a patent claim against a prior art document, the method comprising:
dividing the claim into a plurality of claim elements;
for each claim element, generating at least one prompt for a large language model (LLM) to assess whether the claim element is disclosed by the prior art document, wherein the at least one prompt includes at least a portion of the prior art document, the patent claim, and the claim element;
transmitting each of the prompts to the LLM to a obtain an initial analysis for each claim element;
presenting a claim chart that maps each of the claim elements to the corresponding initial analysis provided by the LLM;
for each initial analysis presented in the claim chart, providing a chat interface to enable a user to engage in a real-time conversation with the LLM, wherein the LLM is instructed to respond to (i) the user's feedback regarding the prior art document or the initial analysis, and (ii) provide an updated analysis of the claim element as a result of the real-time conversation; and
providing the user an option to replace the initial analysis with the updated analysis in the claim chart.

2. The method of claim 1, further comprising the step of providing the user an interface to revise a template for generating the at least one prompt for each claim element.

3. The method of claim 1, wherein the LLM comprises a plurality of LLMs and the method further comprises the step of providing the user an interface to select a different LLM from the plurality of LLMs for generating the initial analysis for each of the claim elements or for responding to the user's feedback through the chat interface.

4. The method of claim 1, wherein the at least one prompt requests the LLM to include in the initial analysis a passage from the prior art document that discloses the claim element if one exists.

5. The method of claim 1, further comprising the steps of:
receiving an identification of a second prior art document to analyze with respect to one of the claim elements;
generating a prompt for the LLM to assess whether there is a motivation to combine the second prior art document with the prior art document to render the claim element obvious, wherein the prompt includes at least a portion of the prior art document, at least a portion of the second prior art document and the claim element;
receiving a motivation to combine analysis from the LLM upon transmitting the prompt to the LLM; and
providing the user an option to add the motivation to combine analysis to the claim chart.

6. The method of claim 5, further comprising the step of providing a chat interface to enable the user to engage in a real-time conversation with the LLM, wherein the LLM is instructed to respond to (i) the user's feedback regarding the motivation to combine analysis, and (ii) provide an updated motivation to combine analysis of the claim element as a result of the real-time conversation.

7. The method of claim 5, further comprising the steps of:
requesting the LLM to generate an analysis of whether the second prior art document discloses the claim element, and
including the generated analysis in the generated prompt to assess whether there is a motivation to combine the second prior art document with the prior art document.

8. A method for generating a plurality of claim charts for a patent claim against a plurality of prior art documents, the method comprising:
dividing the claim into a plurality of claim elements,
for each prior art document with respect to each claim element, generating at least one prompt for a large language model (LLM) to assess whether the claim element is disclosed by the prior art document, wherein the at least one prompt includes at least a portion of the prior art document, the patent claim, the claim element, and a request to provide a rating of the strength of assessment made by the LLM;
transmitting each of the prompts to the LLM to obtain an initial analysis for each claim element with respect to each prior art document, wherein the initial analysis includes a rating of a strength of the initial analysis;
presenting a claim chart for each prior art document that maps each of the claim elements to the corresponding initial analysis provided by the LLM,
for each claim element in each claim chart, assessing whether the rating of its initial analysis of the claim element for the prior art document is weaker than the rating of the initial analysis of the claim element for other prior art documents in the plurality and presenting an option to request that the LLM evaluate a motivation to combine the prior art document with one of the other prior art documents in the plurality if the initial analysis for the prior art document is weaker than the initial analysis for the other prior art document; and
providing the user an option to add a motivation to combine analysis generated by the LLM to the claim chart.

9. The method of claim 8, further comprising, for each initial analysis presented in the claim chart for each prior art document, the steps of:
providing a chat interface to enable a user to engage in a real-time conversation with the LLM, wherein the LLM is instructed to respond to (i) the user's feedback regarding the prior art document or the initial analysis, and (ii) provide an updated analysis of the claim element as a result of the real-time conversation; and
providing the user an option to replace the initial analysis with the updated analysis in the claim chart.

10. The method of claim 9, further comprising, for each motivation to combine analysis generated by the LLM, the step of providing a chat interface to enable the user to engage in a real-time conversation with the LLM, wherein the LLM is instructed to respond to (i) the user's feedback regarding the motivation to combine analysis, and (ii) provide an updated motivation to combine analysis of the claim element as a result of the real-time conversation.

11. The method of claim 8, further comprising the steps of:
enabling the user to identify a portion of the claim element for the LLM to focus upon in generating motivation to combine analysis, and
including the identified portion of the claim element in a prompt to the LLM to generate the motivation to combine analysis.

12. The method of claim 8, further comprising the step of providing the user an interface to revise a template form for (i) generating the at least one prompt for each claim element to assess whether the claim element is disclosed by the prior art document, or (ii) generating a prompt for the LLM to conduct a motivation to combine analysis.

13. The method of claim 8, wherein the LLM comprises a plurality of LLMs and the method further comprises the step of providing the user an interface to select a different LLM from the plurality of LLMs for generating the initial analysis for each of the claim elements or for responding to the user's feedback through the chat interface.

14. The method of claim 8, further providing the user a user interface to divide the patent claim into the claim elements.

15. A system for generating a claim chart for a patent claim against a prior art document, the system comprising a web application configured to:
receive a patent number, a patent claim number and an identifier corresponding to a prior art document;
obtain data relating to the patent number and the prior art document identifier from a patent database service, including the patent and the prior art document;
prompt a large language model (LLM) at a claim element granularity level to assess whether each claim element of the patent claim is disclosed by the prior art document;
generate a claim chart for a user comprising an analysis for each claim element provided by the LLM;
broker a real-time conversation between the user and the LLM to refine the responses from the LLM and update the claim chart based on the refinement; and
store the claim chart in a database service.

16. The system of claim 15, where the web application is further configured to:
receive a least a second identifier corresponding to a second prior art document; and
prompt the LLM to assess whether there is motivation to combine the prior art document with the at least second prior art document; and
broker a real-time conversation between the user and the LLM to refine a motivation to combine analysis provided by the LLM.

17. The system of claim 16, wherein the web application is further configured to:
generate multiple claim charts in parallel corresponding to a plurality of prior art documents by prompting the LLM for each claim element in each claim chart in parallel;
compare the strength of the LLM's analysis across each of the claim elements for each of the prior art documents; and
initiate motivation to combine analyses with the LLM for combinations of a first and second prior art document in the plurality for which (i) an overall assessment of a claim chart for the first prior art document is strong, but (ii) an analysis for a particular claim element for the first prior art document is weaker than an analysis for the particular claim element for the second prior art document.

18. The system of claim 15, wherein the web application is further configured to enable the user to revise default templates user by the web application to prompt the LLM.

19. The system of claim 18, wherein the LLM is a plurality of LLMs and the web application is further configured to enable the user to select different LLMs from the plurality of LLMs for generating the analysis for each claim element or for the real-time conversation.

20. The system of claim 15, where the claim chart is stored in the database service in a data record comprising a plurality of related claim charts relating to a plurality of patents, patent claims and prior art documents.
